(19) United States
(12) Patent Application Publication
(10) Pub. No.: US 2022/0128731 A1
(43) Pub. Date: Apr. 28, 2022

(54) METHOD AND SYSTEM FOR MEASURING AND COMPUTING ENERGY DISTRIBUTION IN THE PROCESS OF INTERCEPTING A ROCKFALL BY A COMBINATION OF A PINE OR CYPRESS WOOD AND AN ARTIFICIAL STRUCTURE

(71) Applicant: INSTITUTE OF GEOLOGY AND GEOPHYSICS, THE CHINESE ACADEMY OF SCIENCES, Beijing (CN)

(72) Inventors: Xueliang WANG, Beijing (CN); Juanjuan SUN, Beijing (CN)

(21) Appl. No.: 17/167,108

(22) Filed: Feb. 4, 2021

Related U.S. Application Data
(63) Continuation of application No. PCT/CN2020/128655, filed on Nov. 13, 2020.

(30) Foreign Application Priority Data
Oct. 27, 2020 (CN) 202011164632.3

(51) Int. Cl. G01V 99/00; G06F 30/20; G06F 17/10

(52) U.S. Cl. CPC G01V 99/005; G06F 17/10; G06F 30/20

(57) ABSTRACT

Disclosed are a method and system for measuring and computing energy distribution in the process of intercepting a rockfall by a combination of a pine or cypress wood and an artificial structure. The amount of rockfall energy that the pine or cypress wood is capable of intercepting, together with the interception energy of the artificial structure in the process of jointly intercepting the movement of the rockfall in conjunction with the pine or cypress wood is computed based on the diameter at breast height (DBH) and average tree spacing of the pine or cypress wood as well as the length of the pine or cypress wood in the direction parallel to the slope surface and the width of the rockfall intercepting area of the pine or cypress wood.

### CROSS-REFERENCE TO RELATED APPLICATIONS

This application is a continuation of co-pending International Patent Application Number PCT/CN2020/128655, filed on Nov. 13, 2020, the disclosure of which is incorporated herein by reference in its entirety.

### TECHNICAL FIELD

This application relates to the technical field of natural disaster prevention and control computations, and particularly relates to a method and system for measuring and computing energy distribution in the process of intercepting a rockfall by a combination of a pine or cypress wood and an artificial structure.

### BACKGROUND

Rockfall is a common type of geological disaster, which seriously threatens the safety of mountain roads, railways, scenic spots, and other human engineering facilities. In the mountainous areas of Southwest China, the vegetation is lush in many mountainous areas due to abundant rainfall and other reasons. These natural or artificial forests or woods play an important role in intercepting rockfalls. Thus, in rockfall prevention and control engineering, in addition to the use of artificial structures and other geotechnical measures, the full play and use of the interception role of the forests or woods is an important measure that not only reduces the risk of rockfall disasters, but also facilitates the construction of ecological environments.

However, the current description of the protection effectiveness of a forest or wood in the process of intercepting a rockfall is still in the qualitative or semi-quantitative stage, and quantitative measurements and computations are still very lacking. In addition, the research and technology on the energy distribution in and the process of the collaborative interception of a rockfall by a forest or wood and an artificial structure are still in its infancy. In present prevention and control of mountain hazards, the design of interception and protection effectiveness of a forest or wood is mainly based on empirical designs, and there is a lack of theoretical guidance and technical standards that are organically coordinated with the interception measures realized by artificial structures. As a result, the designed artificial structures (such as passive protective nets, retaining walls, etc.) often fail to effectively intercept the rockfall due to the overestimation of the interception effect of the forest or wood, resulting in rockfall disasters, or the protection design is too conservative due to the underestimation of the interception effect of the forest or wood, resulting in economic waste.

Therefore, in the engineering design of rockfall disaster prevention and control, we need to accurately measure and compute the interception energy of an existing natural or artificial forest or wood in intercepting the rockfall based on the calculated motion energy of the rockfall, and then design the interception energy of the artificial structure in a reasonable manner. This is an important topic for scientifically, effectively and economically intercepting rockfalls and reducing the risk of rockfall disasters.

### SUMMARY

This application provides a method and system for measuring and computing the energy distribution in the process of intercepting a rockfall by the combination of a pine or cypress wood and an artificial structure, which provide a simple measuring and computing method that is scientific and effective and adapts to engineering needs.

In order to solve the above problems, this application provides the following technical solutions.

There is provided a method for measuring and computing energy distribution in the process of intercepting a rockfall by a combination of a pine or cypress wood and an artificial structure, the including the following operations:

calculating a motion energy E of the rockfall to be prevented or controlled before entering the pine or cypress wood;

determining a rockfall energy E1 to be intercepted by the pine or cypress wood based on the motion energy E of the rockfall to be prevented or controlled before entering the pine or cypress wood:

$${E}_{1} \text{/} b = {Ae}^{B ( \frac{ad}{h} )}$$

where E1 is the rockfall energy to be intercepted by the pine and cypress wood, d is the diameter at breast height (DBH) of the pine and cypress wood, h is the average tree spacing in the pine and cypress wood, a is the length of the pine and cypress wood in the direction parallel to the slope surface, b represents the width of the rockfall intercepting area of the pine or cypress wood, and A and B are constants; and

calculating the remaining energy E2 of the collapsing body after rushing out of the pine or cypress wood using the formula E2=E−E1, where the remaining energy E2 is the designed protection energy of the artificial structure in the rockfall prevention and control engineering.

Embodiments of this application may further adopt the following technical solution. In particular, the operation of calculating the motion energy E of the rockfall to be prevented or controlled before entering the pine or cypress wood may include the following operations:

obtaining the motion energy E of the rockfall to be prevented or controlled before entering the pine or cypress wood through theoretical computation or numerical simulation computation method.

Embodiments of this application may further adopt the following technical solution. In particular, in the operation of determining the rockfall energy E1 to be intercepted by the pine or cypress wood based on the motion energy E of the rockfall to be prevented or controlled before entering the pine or cypress wood, the following operations may be performed:

determining the DBH d and average tree spacing h of the pine or cypress wood, as well as the length a of the pine or cypress wood in the direction parallel to the slope surface through measurements and computations based on a large-scale image or field survey, and determining the width b of the rockfall intercepting area of the pine or cypress wood through an on-site geological survey and prediction.

Embodiments of this application may further adopt the following technical solution. In particular, the pine or cypress wood may be a natural pine or cypress wood or forest that has grown on a mountainside or an artificial pine or cypress wood.

Embodiments of this application may further adopt the following technical solution. In particular, When the pine or cypress wood is a natural pine or cypress wood in the Qilian Mountains, the d=0.2-0.3 m, h=2-3 m, and when the pine or cypress wood has a slope of 40° in the direction parallel to the slope surface and the ratio of horizontal to vertical spacing is 1:1, A=20.39 and B=0.25. For the constants A and B under other slope conditions and ratios of the horizontal to vertical tree spacings, they can be obtained by inversion based on the characteristics of examples of on-site tree protection against historical rockfalls.

Another technical solution adopted in the embodiments of this application is a system for measuring and computing energy distribution in the process of intercepting a rockfall by a combination of pine or cypress wood and an artificial structure, the system including:

a first motion energy computation unit configured for calculating a motion energy E of the rockfall to be guarded against before entering the pine or cypress wood;

a second motion energy computation unit configured for determining a rockfall energy E1 to be intercepted by the pine or cypress wood based on the motion energy E of the rockfall to be prevented or controlled before entering the pine or cypress wood;

$${E}_{1} \text{/} b = {Ae}^{B ( \frac{ad}{h} )}$$

where E1 is the rockfall energy to be intercepted by the pine and cypress wood, d is the diameter at breast height (DBH) of the pine and cypress wood, h is the average tree spacing in the pine and cypress wood, a is the length of the pine and cypress wood in the direction parallel to the slope surface, b represents the width of the rockfall intercepting area of the pine or cypress wood, and A and B are constants; and

a protection energy unit configured for calculating the remaining energy E2 of the collapsing body after rushing out of the pine or cypress wood using the formula E2=E−E1, where the remaining energy E2 is the designed protection energy of the artificial structure in the rockfall prevention and control engineering.

Embodiments of this application may further adopt the following technical solution. In particular, the first motion energy computation unit is configured for obtaining the motion energy E of the rockfall to be prevented or controlled before entering the pine or cypress wood through a theoretical computation or numerical simulation computation method.

Embodiments of this application may further adopt the following technical solution. In particular, the first motion energy computation unit may determine the DBH d and average tree spacing h of the pine or cypress wood, as well as the length a of the pine or cypress wood in the direction parallel to the slope surface through measurements and computations based on a large-scale image or field survey, and determine the width b of the rockfall intercepting area of the pine or cypress wood through an on-site geological survey and prediction.

Embodiments of this application may further adopt the following technical solution. In particular, the pine or cypress wood may be a natural pine or cypress wood or forest that has grown on a mountainside or an artificial pine or cypress wood.

Embodiments of this application may further adopt the following technical solution. In particular, When the pine or cypress wood is a natural pine or cypress wood in the Qilian Mountains, the d=0.2-0.3 m, h=2-3 m, and when the pine or cypress wood has a slope of 40° in the direction parallel to the slope surface and the ratio of horizontal to vertical spacing is 1:1, A=20.39 and B=0.25. For the constants A and B under other slope conditions and ratios of the horizontal to vertical tree spacings, they can be obtained by inversion based on the characteristics of examples of on-site tree protection against historical rockfalls.

Compared with the related art, embodiments of this application may provide the following beneficial effects. According to the method and system for measuring and computing energy distribution during the process of intercepting a rockfall by the combination of a pine or cypress wood and an artificial structure provided by this application, the amount of rockfall energy that the pine or cypress wood is capable of intercepting, together with the interception energy of the artificial structure in the process of jointly intercepting the movement of the rockfall in conjunction with the pine or cypress wood are computed based on the DBH and average tree spacing of the pine or cypress wood as well as the length of the pine or cypress wood in the direction parallel to the slope surface and the width of the rockfall intercepting area of the pine or cypress wood. Thus, this application comprehensively takes into consideration the four factors including the pine or cypress wood's DBH, average tree spacing, the length of the pine or cypress wood in the direction parallel to the slope surface, and the width of the rockfall intercepting area of the pine or cypress wood, which are further combined with the layout characteristics of the optimized combination of interception by trees and interception by an artificial structure to obtain the computation formula for computing the rockfall energy to be intercepted by the pine or cypress wood through data fitting based on actual historical rockfall movements and tree interception characteristic results. Thus, this application can reasonably determine the energy distribution in the interception of the rockfall by the combination of the pine or cypress wood and the artificial structure, providing a scientific basis for the engineering design of rockfall disaster prevention and control. Furthermore, the computation method is simple and can satisfy engineering needs.

### BRIEF DESCRIPTION OF DRAWINGS

FIG. 1 is a flow chart illustrating the operations of a method for measuring and computing energy distribution in the process of intercepting a rockfall by a combination of a pine or cypress wood and an artificial structure in accordance with an embodiment of this application.

FIG. 2 is a block diagram illustrating a system for measuring and computing energy distribution in the process of intercepting a rockfall by a combination of a pine or cypress wood and an artificial structure in accordance with an embodiment of this application.

FIG. 3 is a longitudinal cross-sectional view of a pine or cypress wood in accordance with an embodiment of this application.

FIG. 4 is a schematic top view of a pine or cypress wood in accordance with an embodiment of this application.

### DETAILED DESCRIPTION

For a better understanding of the objections, technical solutions and advantages of this application, the application will be further described in further detail below in connection with the accompanying drawings and embodiments. It should be understood that the specific embodiments described here are merely used to explain the application, and not intended to limit the application.

As used herein, the terms “up”, “down”, “horizontal”, “inside”, “outside”, and the like are used to indicate orientational or positional relationships based on those illustrated in the drawings. They are merely intended for the convenience of illustrating the present disclosure and simplifying the description, rather than indicating or implying that the device or element referred to must have a particular orientation or be constructed and operate in a particular orientation. Therefore, these terms should not be construed as restricting the present disclosure.

In addition, terms like “first”, “second”, etc. are merely used for illustrative purposes, and shall not be construed as indicating or implying relative importance or implicitly indicating the number of specified technical features. Thus, the features defined by “first” and “second” may explicitly or implicitly include one or more of the features. As used herein, the term “a plurality” means two or more, unless specifically defined otherwise.

For a better understanding of the objections, technical solutions and advantages of this application, the application will be further described in further detail below in connection with the accompanying drawings and embodiments.

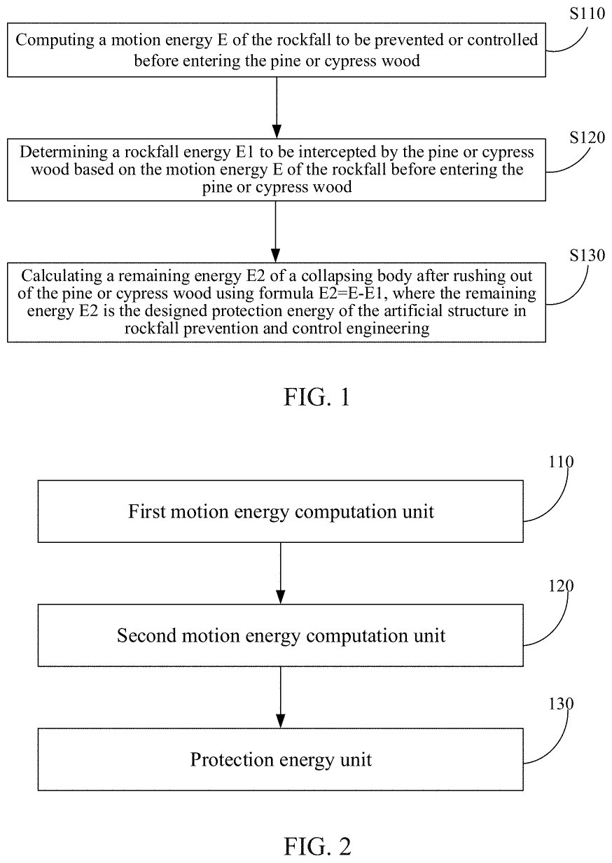

Referring to FIG. 1, the method for measuring and computing energy distribution during the process of intercepting a rockfall by a combination of a pine or cypress wood and an artificial structure according to this application may include the following operations S110, S120, and S130.

In S110, the method may include calculating a motion energy E of the rockfall to be prevented or controlled before entering the pine or cypress wood.

In some of the embodiments, the motion energy E of the rockfall to be prevented or controlled before entering the pine or cypress wood may be obtained through theoretical computation or numerical simulation computation methods.

In S120, the method may include determining a rockfall energy E1 to be intercepted by the pine or cypress wood based on the motion energy E of the rockfall to be prevented or controlled before entering the pine or cypress wood, and

$${E}_{1} \text{/} b = {Ae}^{B ( \frac{ad}{h} )}$$

where E1 (kJ) is the rockfall energy to be intercepted by the pine and cypress wood, d (m) is the diameter at breast height (DBH) of the pine and cypress wood, h (m) is the average tree spacing in the pine and cypress wood, a (m) is the length of the pine and cypress wood in the direction parallel to the slope surface, b (m) represents the width of the rockfall intercepting area of the pine or cypress wood, and A and B are constants.

In some embodiments, the DBH d and average tree spacing h of the pine or cypress wood, as well as the length a of the pine or cypress wood in the direction parallel to the slope surface may be determined through measurements and computations based on a large-scale image or field survey, and the width b of the rockfall intercepting area of the pine or cypress wood may be determined through an on-site geological survey and prediction.

In some embodiments, the pine or cypress wood may be a natural pine or cypress wood or forest that has grown on a mountainside or an artificial pine or cypress wood.

When the pine or cypress wood is a natural pine or cypress wood in the Qilian Mountains, the d=0.2-0.3 m, h=2-3 m, and when the pine or cypress wood has a slope of 40° in the direction parallel to the slope surface and the ratio of horizontal to vertical spacing is 1:1, A=20.39 and B=0.25. For the constants A and B under other slope conditions and ratios of the horizontal to vertical tree spacings, they can be obtained by inversion based on the characteristics of examples of on-site tree protection against historical rockfalls.

In S130, the method may include calculating the remaining energy E2 of the collapsing body after rushing out of the pine or cypress wood using the formula E2=E−E1, where the remaining energy E2 is the designed protection energy of the artificial structure in the rockfall prevention and control engineering.

Compared with the related art, according to the method for measuring and computing energy distribution during the process of intercepting a rockfall by the combination of a pine or cypress wood and an artificial structure provided by this application, the amount of rockfall energy that the pine or cypress wood is capable of intercepting, together with the interception energy of the artificial structure in the process of jointly intercepting the movement of the rockfall in conjunction with the pine or cypress wood are computed based on the DBH and average tree spacing of the pine or cypress wood as well as the length of the pine or cypress wood in the direction parallel to the slope surface and the width of the rockfall intercepting area of the pine or cypress wood. Thus, this application comprehensively takes into consideration the four factors including the pine or cypress wood's DBH, average tree spacing, the length of the pine or cypress wood in the direction parallel to the slope surface, and the width of the rockfall intercepting area of the pine or cypress wood, which are further combined with the layout characteristics of the optimized combination of interception by trees and interception by an artificial structure to obtain the computation formula for computing the rockfall energy to be intercepted by the pine or cypress wood through data fitting based on actual historical rockfall movements and tree interception characteristic results. Thus, this application can reasonably determine the energy distribution in the interception of the rockfall by the combination of the pine or cypress wood and the artificial structure, providing a scientific basis for the engineering design of rockfall disaster prevention and control. Furthermore, the computation method is simple and can satisfy engineering needs.

FIG. 2 illustrates a system for measuring and computing energy distribution in the process of intercepting a rockfall by a combination of a pine or cypress wood and an artificial structure in accordance with an embodiment of this application. The system includes a first motion energy computation unit 110, a second motion energy computation unit 120, and a protection energy unit 130.

The first motion energy computation unit 110 is configured for calculating a motion energy E of the rockfall to be prevented or controlled before entering the pine or cypress wood.

In some of the embodiments, the first motion energy computation unit 110 may obtain the motion energy E of the rockfall to be prevented or controlled before entering the pine or cypress wood through theoretical computation or numerical simulation computation methods.

The second motion energy computation unit 120 is configured for determining a rockfall energy E1 to be intercepted by the pine or cypress wood based on the motion energy E of the rockfall to be prevented or controlled before entering the pine or cypress wood;

$${E}_{1} \text{/} b = {Ae}^{B ( \frac{ad}{h} )}$$

where E1 (kJ) is the rockfall energy to be intercepted by the pine and cypress wood, d (m) is the diameter at breast height (DBH) of the pine and cypress wood, h (m) is the average tree spacing in the pine and cypress wood, a (m) is the length of the pine and cypress wood in the direction parallel to the slope surface, b (m) represents the width of the rockfall intercepting area of the pine or cypress wood, and A and B are constants.

In some embodiments, the second motion energy computation unit 120 may determine the DBH d and average tree spacing h of the pine or cypress wood, as well as the length a of the pine or cypress wood in the direction parallel to the slope surface through measurements and computations based on a large-scale image or field survey, and determine the width b of the rockfall intercepting area of the pine or cypress wood through an on-site geological survey and prediction.

In some embodiments, the pine or cypress wood may be a natural pine or cypress wood or forest that has grown on a mountainside or an artificial pine or cypress wood.

When the pine or cypress wood is a natural pine or cypress wood in the Qilian Mountains, the d=0.2-0.3 m, h=2-3 m, and when the pine or cypress wood has a slope of 40° in the direction parallel to the slope surface and the ratio of horizontal to vertical spacing is 1:1, A=20.39 and B=0.25. For the constants A and B under other slope conditions and ratios of the horizontal to vertical tree spacings, they can be obtained by inversion based on the characteristics of examples of on-site tree protection against historical rockfalls.

The protection energy unit 130 is configured for calculating the remaining energy E2 of the collapsing body after rushing out of the pine or cypress wood using the formula E2=E−E1 130 where the remaining energy E2 is the designed protection energy of the artificial structure in the rockfall prevention and control engineering.

Compared with the related art, according to the system for measuring and computing energy distribution during the process of intercepting a rockfall by the combination of a pine or cypress wood and an artificial structure provided by this application, the amount of rockfall energy that the pine or cypress wood is capable of intercepting, together with the interception energy of the artificial structure in the process of jointly intercepting the movement of the rockfall in conjunction with the pine or cypress wood are computed based on the DBH and average tree spacing of the pine or cypress wood as well as the length of the pine or cypress wood in the direction parallel to the slope surface and the width of the rockfall intercepting area of the pine or cypress wood. Thus, this application comprehensively takes into consideration the four factors including the pine or cypress wood's DBH, average tree spacing, the length of the pine or cypress wood in the direction parallel to the slope surface, and the width of the rockfall intercepting area of the pine or cypress wood, which are further combined with the layout characteristics of the optimized combination of interception by trees and interception by an artificial structure to obtain the computation formula for computing the rockfall energy to be intercepted by the pine or cypress wood through data fitting based on actual historical rockfall movements and tree interception characteristic results. Thus, this application can reasonably determine the energy distribution in the interception of the rockfall by the combination of the pine or cypress wood and the artificial structure, providing a scientific basis for the engineering design of rockfall disaster prevention and control. Furthermore, the computation method is simple and can satisfy engineering needs.

Hereinafter, the above-described solutions will be described in greater detail in connection with some specific embodiments.

### Embodiment

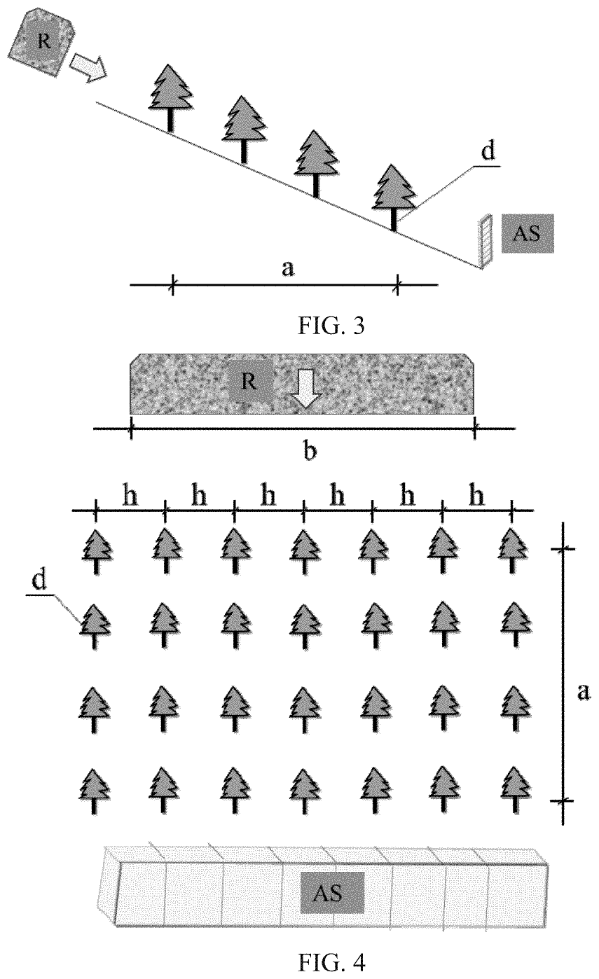

FIGS. 3 and 4 show a longitudinal cross-sectional view and a schematic top view of a pine or cypress wood, respectively. In the figures, R represents a rockfall, AS represents an Artificial Structure, d denotes the trees' diameter at breast height, h represents the average tree spacing, a represents the length of the pine or cypress wood in the direction parallel to the slope surface, and b is the length of the rockfall intercepting area of the pine or cypress wood.

An example hidden hazard point of rockfall is the rockfall above a walking trail in Shenxianju Scenic Area, Xianju County. The collapsing body has an area of 200 m2 and a height of 260 m. The collapsing body is a cliff rock mass, and the slope below it has an average inclination of 42° with a lush pine wood growing thereon. The lithology of the collapsing body is tuff, and the collapsing body is severely cut in its structural planes, which provides favorable topographic and geological conditions for the formation and movement of a rockfall.

In order to ensure safe tourism and mitigate a potential rockfall disaster, it is proposed to set up a rockfall protection project of a pine wood plus a passive protection net on the outside of the walking trail under the collapsing body. Below, the rockfall energy to be intercepted by this pine wood, as well as the design energy of the passive protection net is computed as follows.

First, the motion energy E of the rockfall to be prevented or controlled before entering the pine wood is computed by means of three-dimensional numerical simulation, as E=17560 kJ.

Second step, the rockfall energy E1 to be intercepted by the pine wood is computed using the following formula

$${E}_{1} \text{/} b = {Ae}^{B ( \frac{ad}{h} )} ,$$

to obtain E1=8191 KJ. Based on this, the energy distributed to the pine wood during the rockfall intercepting process can be obtained. In particular, through field surveys, it is determined that the DBH d of the pine wood is 0.2 m, the average tree spacing h of the pine wood is equal to 2 m, the length a of the pine wood in the direction parallel to the slop surface is equal to 120 m, and the width b of the pine wood in the direction perpendicular to the slope direction is 20 m.

Third, the formula E2=E−E1 is used to determine E2=E−E1=9369 kJ is determined by the. This energy is the remaining energy of the collapsing body after running out of the pine wood.

As such, the energy distributed to the passive protection net in the process of intercepting the rockfall after it rushes out of the pine wood can be obtained.

The foregoing description of the disclosed embodiments will enable those having ordinary skill in the art to implement or use this application. Various changes or modifications to these embodiments will be obvious to those having ordinary skill in the art, and the general principles defined in this document can be implemented in other embodiments without departing from the spirit or scope of the present application. Therefore, this application will not be limited to the embodiments illustrated in this document, but should assume the widest scope consistent with the principles and novel features disclosed in this document.

What is claimed is:

1. A method for measuring and computing energy distribution in a process of intercepting a rockfall by a combination of a pine or cypress wood and an artificial structure, the method comprising:
computing a motion energy E of the rockfall to be prevented or controlled before entering the pine or cypress wood;
determining a rockfall energy E1 to be intercepted by the pine or cypress wood based on the motion energy E of the rockfall before entering the pine or cypress wood using the following formula;
$$E 1 \text{/} b = {Ae}^{B ( \frac{ad}{h} )} ;$$
where E1 is the rockfall energy to be intercepted by the pine and cypress wood, d represents a diameter at breast height (DBH) of the pine and cypress wood, h represents an average tree spacing in the pine and cypress wood, a represents a length of the pine and cypress wood in a direction parallel to a slope surface, b represents a width of a rockfall intercepting area of the pine or cypress wood, and A and B are constants;
calculating a remaining energy E2 of a collapsing body after rushing out of the pine or cypress wood using formula E2=E−E1; and
taking the remaining energy E2 as a designed protection energy of the artificial structure in rockfall prevention and control engineering.

2. The method as recited in claim 1, wherein the operation of computing the motion energy E of the rockfall to be prevented or controlled before entering the pine or cypress wood comprises:
obtaining the motion energy E of the rockfall to be prevented or controlled before entering the pine or cypress wood through a theoretical computation or numerical simulation computation method.

3. The method as recited in claim 2, wherein the operation of determining the rockfall energy E1 to be intercepted by the pine or cypress wood based on the motion energy E of the rockfall before entering the pine or cypress wood comprises:
determining the DBH d and average tree spacing h of the pine or cypress wood and the length a of the pine or cypress wood in the direction parallel to the slope surface through measurements and computations based on a large-scale image or field survey, and determining the width b of the rockfall intercepting area of the pine or cypress wood through an on-site geological survey and prediction.

4. The method as recited in claim 3, wherein the pine or cypress wood is a natural pine or cypress wood or forest that has grown on a mountainside or an artificial pine or cypress wood.

5. The method as recited in claim 4, wherein when the pine or cypress wood is a natural pine or cypress wood or forest in Qilian Mountains, d lies in the range of 0.2 to 0.3 m, h lies in the range of 2 to 3 m, and wherein when the pine or cypress wood has a slope of 40° in the direction parallel to the slope surface and a ratio of horizontal to vertical spacing is 1:1, A is equal to 20.39 and B is equal to 0.25.

6. The method as recited claim 5, wherein when the values of the constants A and B determined by inversion based on characteristics of examples of on-site tree protection against historical rockfalls under other slope conditions and ratios of the horizontal to vertical tree spacings.

7. A system for measuring and computing energy distribution in a process of intercepting a rockfall by a combination of a pine or cypress wood and an artificial structure, the system comprising:
a first motion energy computation unit, configured for calculating a motion energy E of the rockfall to be prevented or controlled before entering the pine or cypress wood;
a second motion energy computation unit, configured for determining a rockfall energy E1 to be intercepted by the pine or cypress wood based on the motion energy E of the rockfall before entering the pine or cypress wood using the following formula;
$$E 1 \text{/} b = {Ae}^{B ( \frac{ad}{h} )} ;$$
where E1 is the rockfall energy to be intercepted by the pine and cypress wood, d represents a diameter at breast height (DBH) of the pine and cypress wood, h represents an average tree spacing in the pine and cypress wood, a represents a length of the pine and cypress wood in a direction parallel to a slope surface, b represents a width of a rockfall intercepting area of the pine or cypress wood, and A and B are constants; and
a protection energy unit, configured for calculating a remaining energy E2 of a collapsing body after rushing out of the pine or cypress wood using formula E2=E−E1, wherein the remaining energy E2 is taken as a designed protection energy of the artificial structure in rockfall prevention and control engineering.

8. The system as recited in claim 7, wherein the first motion energy computation unit is configured for obtaining the motion energy E of the rockfall to be prevented or controlled before entering the pine or cypress wood using a theoretical computation or numerical simulation computation method.

9. The system as recited in claim 8, wherein the first motion energy computation unit is configured for determining the DBH d and average tree spacing h of the pine or cypress wood and the length a of the pine or cypress wood in the direction parallel to the slope surface through measurements and computations based on a large-scale image or field survey, and determining the width b of the rockfall intercepting area of the pine or cypress wood through an on-site geological survey and prediction.

10. The system as recited in claim 9, wherein the pine or cypress wood is a natural pine or cypress wood or forest that has grown on a mountainside or an artificial pine or cypress wood.

11. The system as recited in claim 10, wherein when the pine or cypress wood is a natural pine or cypress wood in Qilian Mountains, d lies in the range of 0.2 to 0.3 m, h lies in the range of 2 to 3 m, and wherein when the pine or cypress wood has a slope of 40° in the direction parallel to the slope surface and a ratio of horizontal to vertical spacing is 1:1, A is equal to 20.39 and B is equal to 0.25.

12. The system as recited in claim 11, wherein when the values of the constants A and B determined by inversion based on characteristics of examples of on-site tree protection against historical rockfalls under other slope conditions and ratios of the horizontal to vertical tree spacings.
